(19) United States
(12) Patent Application Publication
(10) Pub. No.: US 2007/0178280 A1
(43) Pub. Date: Aug. 2, 2007

(54) Method of pattern coating

(76) Inventors: Christopher L. Bower, Headington (GB); Elizabeth A. Simister, Watford (GB); Terence D. Blake, Tring (GB); Eleanor Bonnist, Minehead (GB)

Correspondence Address: Patent Legal Staff, Eastman Kodak Company, Rochester, NY, 14650-2201, US

(21) Appl. No.: 10/573,711

(22) PCT Filed: Jun. 18, 2004
(86) PCT No.: PCT/GB04/02591

§ 371 Date: Dec. 5, 2006

(30) Foreign Application Priority Data
Jul. 18, 2003 (GB) 0316926.5

(51) Int. Cl. B05D 5/00; G11B 5/64; B32B 17/10

(52) U.S. Cl. 428/141; 427/261; 428/409

(57) ABSTRACT

A method of coating well defined discrete areas of a flexible substrate by creating a lyophobic pattern on the surface of the web to leave a desired pattern of lyophilic areas. A layer of coating solution is laid down over the patterned web, the solution withdrawing from the lyophobic areas and collecting on the lyophilic areas.

### FIELD OF THE INVENTION

The present invention relates to the field of coating, in particular to the roll to roll coating of well defined discrete areas of a continuous web of material.

### BACKGROUND OF THE INVENTION

It is known to use the basic principle of differential wetting to rearrange liquids on a solid support, such as a silicon wafer. The general principle relies on the liquid spontaneously moving from the lyophobic (solvent hating) areas onto the lyophilic (solvent loving) areas of the substrate or support.

WO 02/38386 discloses a process and apparatus for formation of patterns using temperature gradients. Thermal gradients are used to rearrange liquids after coating.

EP 0882593 discloses a method of forming a hydrophobic/hydrophilic front face of an inkjet printer. Hydrophobic surfaces are required around the nozzles of an inkjet head to repel ink from the nozzle and hydrophilic regions are required to pull ink away from the hydrophobic regions.

WO 01/62400 discloses the use of a hydrophobic effect to create polymer micro lens arrays by dip coating a support with patterned wettability.

U.S. Pat. No. 6,048,623 discloses a method of contact printing on gold coated films. This is used to create self assembled monolayers using an elastomeric stamp WO 01/47045 discloses the fabrication of electronic devices on flexible plastic substrates using self assembled monolayers to limit the spread of inkjet printed polymers.

Problem to be Solved by the Invention

All the known prior art is concerned with batch processed supports. None of the prior art discloses a technique for the use of any means of differential wetting for the production of coated webs of flexible material in a roll to roll manner. It is desirable to be able to deposit a liquid onto specified regions of the flexible material whilst leaving other regions uncoated.

### SUMMARY OF THE INVENTION

The method of the invention utilises the controlled deposition of a liquid to produce a pattern on the support. This is achieved by patterning the support web with a hydrophobic or an oleophobic (to allow patterning of aqueous liquids or of non-aqueous liquids respectively) material to form a mask. The mask re-arranges the coated liquid into the desired pattern by altering the wettability of the support A lyophilic surface pattern may alternatively be created.

According to the present invention there is provided a method of coating well defined discrete areas of a flexible substrate in a continuous roll to roll manner, the method comprising the steps of creating a lyophobic or lyophilic surface pattern on the substrate, a desired pattern of lyophilic or lyophobic areas being left, overcoating the created surface pattern with a layer of coating solution, the solution withdrawing from the lyophobic areas and collecting on the lyophilic areas.

Preferably the patterning of the support web is performed inline, i.e. prior to the coating solution to allow the discrete coating to be performed in a single pass.

Advantageous Effect of the Invention

The method of the invention enables roll to roll continuous discrete patterned coating which has significant cost and productivity benefits over batch processes. As only desired areas are coated it ensures cost effective use of materials. It enables the low cost manufacture of, for example, flexible displays, electronics, OLED's, PLEDs, touch-screens, fuel-cells, solid state lighting, photovoltaic and other complex opto-electronic devices.

### BRIEF DESCRIPTION OF THE DRAWINGS

The invention will now be described with reference to the accompanying drawings in which:

FIG. 1 shows an example of a mask pattern that may be transferred onto the web of material;

FIG. 2 is a graph comparing experimental results with theory;

FIG. 3 shows calculated recession rates as a function of equilibrium contact angles; and

FIGS. 4a and 4b illustrate the improvement in coating uniformity when surfactant is added.

### DETAILED DESCRIPTION OF THE INVENTION

FIG. 1 shows an example of a mask pattern that may be created on a web of material or substrate. The substrate may be made of paper, plastic film, resin coated paper, synthetic paper or a conductive material. These are examples only.

The invention is not limited to the pattern shown in FIG. 1. A mask material may be deposited on the support using a flexographic printer roller. Alternative methods of creating the mask include; gravure coating, offset printing, screen printing, plasma deposition, photolithography, micro-contact printing, inkjet printing or selective removal of a uniform layer of the material by laser or other etching technique, optically writing with light or a laser, electrostatic spray or by plasma treatment. These are examples only and it will be understood by those skilled in the art that any suitable means may be used to create the mask pattern. The material used for the mask in the experiments described below was a layer of fluoropolymer. However the invention is not limited to such mask material. Other materials that might be used include aqueous based silicone release agents, or a chemical species containing one or more lyophobic moieties and one or more adhesive moieties.

In order to allow further layers of coating solution to be coated onto the substrate it is necessary to change the lyophobic mask or surface pattern to lyophilic so that the next layer of solution coats uniformly. This layer can then remain as a uniform layer or acts as a further substrate onto which a further mask pattern can be created and a further solution coated. Third and subsequent patterned layers would be formed in the same way. There are various methods of switching the wettabililty of the material such as temperature, light, pH, electrostatics. The materials might be based around liquid crystal polymers or alumina/titania/Teflon composites. Alternatively the original surface pattern could be removed.

Once the mask or surface pattern has been created on the web of material or substrate it is then overcoated by the desired liquid or layers of liquid. This may be done equally well by either pre or post metered coating processes. For example the coating solution may be deposited on the substrate by means of, for example, bead coating or curtain coating, by means of a blade, roll, gravure, air knife, by inkjet or by electrostatic spray. The liquid is then directed in such a way that the coated layer recedes from the lyophobic areas and collects on the lyophilic areas. When multiple layers are overcoated simultaneously the layer structure is maintained, thus allowing perfect registration of all the layers with the mask pattern. The web of material is then dried and/or cured. The liquid may be a solvent. The liquid used as the coating solution may be a gelatin based material. The coating solution may be chosen for specific properties that it may have. For instance the coating solution may be chosen for its conductive properties or photonic properties. A further example would be the use of liquid crystal material as the coating solution. The coating solution may comprise a dispersion of carbon nano tubes. This provides a coating with excellent conductivity and transparency and which may be used for the production of transparent conductors. It will be understood that the particular coating solution used will be chosen dependent on the use to which the coated web will be put. Examples include, but are not limited to, optoelectronic devices such as flexible displays and components of displays, organic lasers, light guides, lens arrays or more complex integrated optics, patterned conductive layers, lighting panels, solar cells, three dimensional structured layers of ink jet printers and microelectromechanical systems.

The speed at which the liquid or solution used as the coating layer rearranges on the masked or patterned surface of the web is an important factor in defining the speed at which the discrete areas can be coated in a roll to roll operation. The rates of recession of liquids from lyophobic surfaces can be found in published literature and theory, (as shown for example in F. Brouchard-Wyart and P. G. de Gennes, Advan. Colloid Interface Sci. 39 (1992)), predicts that the rate of recession V of a liquid film from a lyophobic solid surface should follow the simple relationship:

$$V = 0.006 ( \frac{γ}{η} ) {( θ )}^{3} \qquad ( 1 )$$

where γ is the surface tension of the liquid, η is the viscosity of the liquid and θ is the equilibrium contact angle of the liquid on the mask, expressed in radians. If the liquid is coated as a uniform layer, it is necessary to destabilise the layer so that it moves from masked to unmasked regions. This may be achieved by using broad hydrophobic/oleophobic bands on the edge of the coating, or by using a device to create small circular holes in the coating at the desired time and location.

If the coating solution is dilute enough, and when it becomes sufficiently thin during drying, spontaneous dewetting from the lyophobic areas to the lyophilic areas takes place, without the need for any active destabilisation.

The following examples illustrate the method of the invention.

Both hand and machine coatings were made. Experiments were carried out using the format of an array of rectangles using a flexographic proofing system to print a mask followed either by hand coatings or bead coating. The relationship between the dewetting speed V, the surface tension γ of the liquid, the viscosity η of the liquid and the equilibrium contact angle θ of the liquid on the masked area was established. It was shown that the higher the contact angle of the liquid on the masked area the greater the rate of dewetting. Significant coating speeds are possible with a receding contact angle of 50°, preferably 90°, or more on the lyophobic region. In order that the coating solution does not recede from the lyophilic regions the receding angle of the solution from the lyophilic region should be as close to zero degrees as possible. For practical systems the receding angle should be less than 10° and preferably less than 5°. This will ensure good adhesion between the coating solution and the lyophilic region. It was also shown that it is preferable that the created masking surface material is highly uniform The thickness of the masking surface is of the order of 1 μm. Microscopic defects in the layer inhibit retraction of the liquid from the mask. This results in an irregular coating pattern. The coating in this instance was a gelatin melt. However a wide range of aqueous or non aqueous liquids can also be used, such as, but not limited to, conductive polymers, liquid crystals, photonic materials, OLED and PLED materials. Addition of a small amount of surfactant was also found to significantly improve the retraction rate with gelatin based solutions. The addition of surfactant can also be used to improve the uniformity of the resulting coatings.

### EXAMPLES

Hydrophobic masks were printed onto 12.7 cm (5 inch) wide gelatin subbed Polyethylene Teraphlalate support using a Rotary Koater flexographic printing device made by RK Print Coat Instruments Ltd. The same support material, or substrate, was used in the four examples. The photopolymer transfer roller was patterned to print the mask leaving an array of 15mm×31 mm rectangles. The pattern is shown in FIG. 1. The black regions are the hydrophobic regions.

Various fluoropolymer lyophobic “inks” were printed:
a) Cytonix FluoroPel PFC 804A
b) Cytonix FluoroPel PFC GH (epoxy-based fluoropolymer, thermally cured)
c) Cytonix FluoroPel PFC 804A (approx. 16%, concentrated by rotary evaporation)
d) Cytonix FluoroPel PFC 604A
e) Cytonix FluoroPel PFC 504A

All the inks used except the concentrated PFC 804A were of low viscosity (order 1 cP).

The solutions used to overcoat the mask were as follows:

Hand Coatings:

### Example 1

Hand Coatings with Aqueous Glycerol (20, 50 and 100 cP)

### Example 2

Hand Coating with PEDOT/PSS, Cholesteric Liquid Crystal Dispersion in Gelatin

Roll to Roll Bead Coatings:

### Example 3

6% Gelatin+Aqueous Blue Dye

### Example 4

6% Gelatin+0.01% 10 G+Aqueous Blue Dye

Results

### Example 1

Recession rates (taken from video recordings) for three aqueous glycerol solutions on the PFC GH mask are shown in Table 1 together with their respective viscosities, surface tensions and estimated contact angles. The contact angles were determined from video images of 200-300 microlitre drops of water (approximating aqueous glycerol) placed onto the surface of the mask under ambient conditions; surface tensions of the coating solutions were measured using a Wilhelmy blade.

TABLE 1
Contact angle and recession rate data obtained
with aqueous glycerol solutions.

| Contact angle | Viscosity | Surface Tension | Recession Velocity |
|---|---|---|---|
| (deg) | (cP) | (mN/m) | (cm/s) |
| 100 | 100 | 64.2 | 2.2 |
| 100 | 50 | 64.9 | 4.4 |
| 100 | 20 | 65.1 | 12.3 |

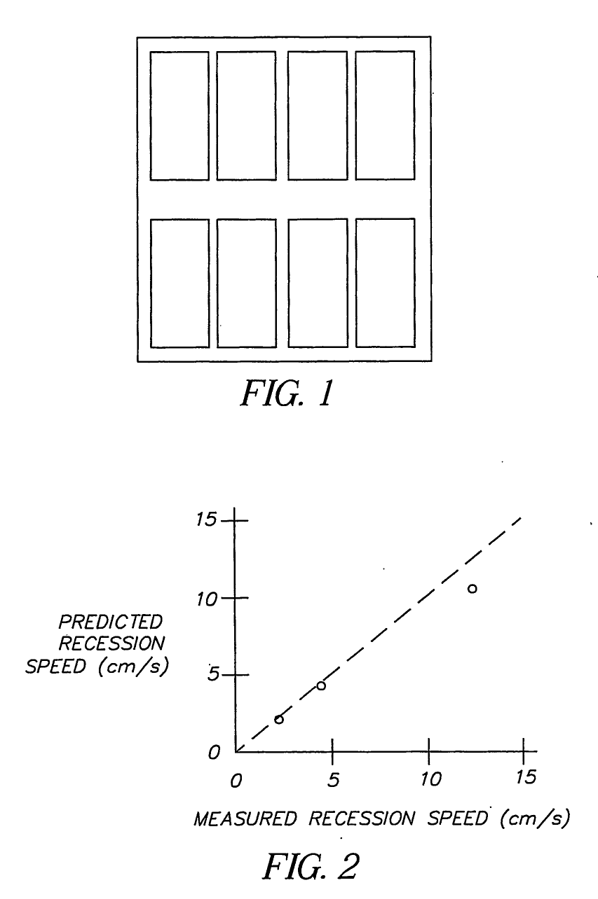

FIG. 2 compares these results with the predictions of equation 1.

The combined data supports equation 1 quite well, but suggests that the numerical factor should be approximately 0.007 rather than 0.006.

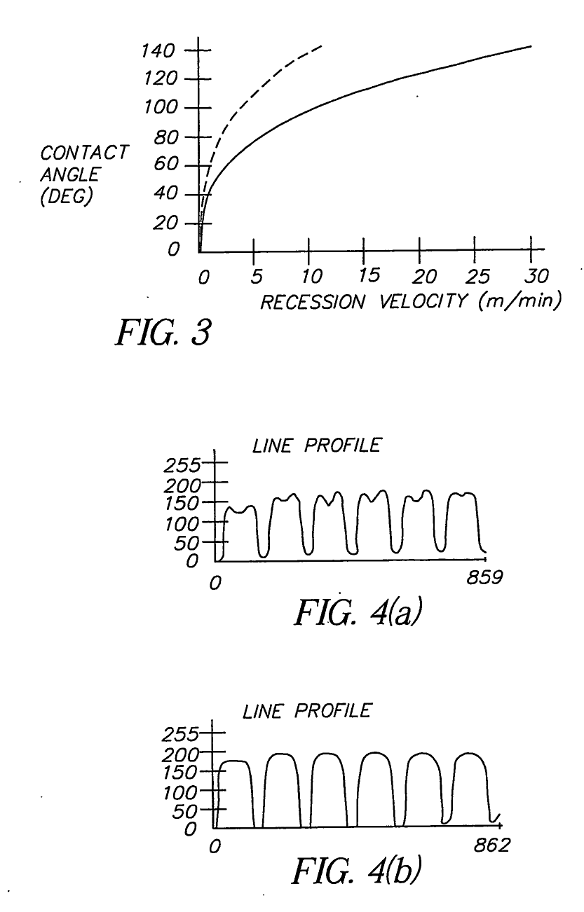

The above results enable the roll to roll speed at which continuous discrete coating can be carried out to be estimated. If reasonable parameters for coating solutions are taken, say γ=50-35 mN/m and η=10-20 cP, and the numerical parameter assumed to be 0.007, then it is possible to calculate the probable recession speeds that would be available for a given contact angle. FIG. 3 shows the upper and lower bounds for these values.

### Example 2

The second example used hand coatings of a gelatin based cholesteric liquid crystal (CLC) dispersion on a 604A mask material. A short section (˜30 cm long) of the hydrophobic mask was overcoated with CLC using an RK instruments K Control Koater with the blade height set to 150 micrometers and speed setting of 10. The material showed good retraction from the masked regions into the unmasked rectangles. An identical experiment using PEDOT/PSS (Aldrich) solution to overcoat the mask was also performed, again showing good retraction of the liquid into discrete coated rectangles.

### Example 3

In the third example, web speed was set at 8 m/min, with a wet laydown of coating solution of 60 micrometers. The mask material, as in example 2, was 604 A. A 4 inch (10.16 cm) wide bead hopper was used. Suction was varied and best results were found when suction was set low, just above break-line conditions (0.5-1 cm water gauge). This appeared to provide a slight destabilising effect that triggered early onset of coating solution rupture and recession. The coatings were chilled inline soon after the coating point. For gelatin-based coating melts, it was important not to set the temperature too low, otherwise the melt set before rearrangement was complete. Best results were achieved at 30° C.

### Example 4

In the fourth example, web speed was set at 8 m/min and the wet laydown of coating solution was increased to 100 micrometers. The mask material remained the same as in example 3. Minimum suction was applied to keep the coating stable but near the break-line condition (0.7-3 cm water gauge, depending on melt viscosity). Temperature was again set at 30° C. In this case the addition of the surfactant, 10 G, to the coating solution improved both the retraction rate and the uniformity of the final coating. Other concentrations of the surfactant 10 G were found to work, up to 1% w/w. The cross-width uniformity of the coating was also improved by the use of a device to create small holes in the coating at the correct spatial and temporal frequency so as to coincide with the intersections of the rectangles on the mask. This was achieved in the example by the use of fine air jets but may equally be achieved by any other suitable method, such as, for example, the use of small drops of repellancy forming liquid or mechanically touching the surface with a lyophobic rod.

Other non-ionic and anionic surfactants were found to improve the uniformity, e.g. Triton X200, Triton X100, Sodium Dodecyl Sulphate, Alkanol XC, Aerosol OT

FIGS. 4a and 4b illustrate a line profile taken through the coating with respect to example 3 and example 4 respectively. It can be seen that example 4 shows improvement in cross width and cell uniformity.

The results of this study demonstrate that given the right selection of lyophobic inks, continuous discrete coating is capable of producing patch-wise discrete coatings by a continuous roll to roll method.

The method has particular application to coating electronic displays. However the method is not limited to such application. Continuous discrete patterned coating as described above, alone or in combination with other techniques such as screen printing, is useful in a wide range of high value products. Examples include optoelectronic devices such as flexible displays and organic lasers, light guides, lens arrays or more complex integrated optic, patterned conductive layer, lighting panels, solar cells, three dimensional structured layers of ink jet printers and microelectromechanical systems.

The invention has been described in detail with reference to preferred embodiments thereof. It will be understood by those skilled in the art that variations and modifications can be effected within the scope of the invention. For example, while the examples described have been directed towards creating a lyophobic pattern on the flexible substrate, leaving lyophilic areas, the method works equally well creating a lyophilic pattern on the substrate to leave lyophobic areas.

1. A method of coating well defined discrete areas of a flexible substrate in a continuous roll to roll manner, the method comprising the steps of creating a lyophobic or lyophilic surface pattern on the substrate, a desired pattern of lyophilic or lyophobic areas being left, overcoating the created surface pattern with a layer of coating solution, the solution withdrawing from the lyophobic areas and collecting on the lyophilic areas.

2. A method as claimed in claim 1 wherein the coating solution comprises more than one distinct layer, simultaneously overcoated.

3. A method as claimed in claim 1 wherein the surface pattern is created on the substrate by means of one of: flexographic printing, offset printing, gravure printing, screen printing, lithography, inkjet (continuous or drop on demand), micro contact printing, plasma deposition, plasma treatment, electrostatic spray or optical means using light or a laser to write the pattern.

4. A method as claimed in claim 1 wherein the steps of creating a surface pattern on the substrate and overcoating the surface pattern with one or more layers of coating solution takes place inline.

5. A method as claimed in claim 1 wherein the created surface pattern comprises a fluoropolymer material.

6. A method as claimed in claim 1 wherein the created surface pattern includes a silicone release agent.

7. A method as claimed in claim 1 wherein the created surface pattern comprises a chemical species containing one or more lyophobic moieties and one or more adhesive moieties.

8. A method as claimed in claim 1 wherein the coating solution is a solvent based solution.

9. A method as claimed in claim 1 wherein the coating solution is a gelatin based material.

10. A method as claimed in claim 1 wherein the coating solution is a polymeric material.

11. A method as claimed in claim 1 wherein the coating solution has conductive and/or photonic properties.

12. A method as claimed in claim 1 wherein the coating solution comprises a dispersion of carbon nanotubes.

13. A method as claimed in claim 1 wherein the coating solution includes liquid crystal material.

14. A method as claimed in claim 1 wherein the coating solution includes surfactant.

15. A method as claimed in claim 1 wherein the coating solution is subsequently dried and/or cured.

16. A method as claimed in claim 1 wherein the composition of the coating solution is sufficiently dilute such that during drying spontaneous dewetting from the lyophobic areas takes place.

17. A method as claimed in claim 1 wherein the coating solution is destabilised at set spatial and temporal locations of the coating.

18. A method as claimed in claim 1 wherein the surface pattern is switched from lyophobic to lyophilic, or vice versa, by means of one of: temperature, light, pH, electrostatic field, magnetic field.

19. A method as claimed in claim 18 wherein a further layer or layers of coating solution is applied over the first overcoat to create a further substrate onto which a further pattern may be created and/or further layers of coating solutions applied.

20. A method as claimed in claim 1 wherein the lyophobic surface yields a receding contact angle with the coating solution of 50° or more and the lyophilic surface yields a receding angle of 10° or less.

21. A method as claimed in claim 1 wherein the lyophobic surface yields a receding contact angle with the coating solution of 90° or more and the lyophilic surface yields a receding angle of 5° or less.

22. A method as claimed in claim 1 wherein the coating solution is deposited onto the created surface pattern by a pre-metered coating process.

23. A method as claimed in claim 1 wherein the coating solution is deposited onto the created surface pattern by a post metered coating process.

24. A method as claimed in claim 1 wherein the coating solution is deposited onto the created surface pattern by means of one of: bead coating, curtain coating, by blade, roll, gravure, air knife, inkjet, electrostatic spray.

25. A method as claimed in claim 1, wherein the substrate is made of a material selected from the group consisting of paper, plastic films, resin-coated paper, synthetic paper, or conductive material.

26. A display device or component thereof formed by the method of claim 1.

27. A flexible display device or component thereof formed by the method of claim 1.

28. A transparent conductor formed at least in part by the method of claim 1.

29. A patterned layer on a support formed by the method of claim 1.
